(19) United States
(12) Patent Application Publication
(10) Pub. No.: US 2026/0084307 A1
(43) Pub. Date: Mar. 26, 2026

(54) SYSTEM AND METHOD FOR SUPPORTING WORK THROUGH COLLABORATION WITH COLLABORATIVE ROBOT

(71) Applicant: ELECTRONICS AND TELECOMMUNICATIONS RESEARCH INSTITUTE, Daejeon (KR)

(72) Inventors: Seung-Jun LEE, Daejeon (KR); Cheonin OH, Daejeon (KR); Daesub YOON, Daejeon (KR); Daewoong CHOI, Daejeon (KR)

(73) Assignee: ELECTRONICS AND TELECOMMUNICATIONS RESEARCH INSTITUTE, Daejeon (KR)

(21) Appl. No.: 19/096,939

(22) Filed: Apr. 1, 2025

(30) Foreign Application Priority Data
Sep. 25, 2024 (KR) 10-2024-0129921

(51) Int. Cl. B25J 9/16

(52) U.S. Cl. CPC B25J 9/1679; B25J 9/1697

(57) ABSTRACT

A method of supporting work through collaboration with a collaborative robot includes a posture estimation unit that estimates posture and body information of a worker based on an image of the worker captured through a posture recognition camera module provided on one side of the worker and that estimates the state of the worker based on the estimated posture and body information of the worker, an object recognition unit that recognizes a work object article and the worker through an object recognition camera module provided over the worker and that measures a distance between the work object article and the worker, and a collaborative robot that transports the work object article in front of the worker by moving based on the estimated state of the worker provided by the posture estimation unit and the measured distance between the work object article and the worker provided by the object recognition unit.

### CROSS-REFERENCE TO RELATED APPLICATION

This application claims priority to and the benefit of Korean Patent Application No. 10-2024-0129921, filed on Sep. 25, 2024, the disclosure of which is incorporated herein by reference in its entirety.

### BACKGROUND

### 1. Technical Field

The present disclosure relates to a method of a worker and a collaborative robot collaborating on work that performs screw assembly in a product manufacturing factory, and more particularly, to a method of a collaborative robot transporting a work object article in front of a worker and the worker performing screw assembly through an electric driver and to a collaborative method of a collaborative robot managing a work order and of collecting a work posture of a worker in real time in order to reduce a load attributable to the order of a work object article to be assembled and a work posture of the worker.

This work was supported by Institute of Information & communications Technology Planning & Evaluation (IITP) grant funded by the Korea government (MSIT) (RS-2022-00167198) and Horizon Europe Framework Program of the European Commission “AI Powered Human-Centered Robot Interactions for Smart Manufacturing (AI-PRISM)” (Grant Number: 101058589)

### 2. Related Art

In the manufacturing industry, processes for production and assembly through machine automation are gradually increased even without humans. Furthermore, due to the supply of collaborative robots, there are rising expectations for an automation work even in a small-sized factory.

The collaborative robot has advantages of a small size and a low cost and relatively easy programming of work compared to an industrial robot, but has disadvantages that parts need to be purchased depending on the tasks assigned and may need to be replaced.

For example, in order to automate work that a collaborative robot performs screw assembly on a substrate, a multi-axis nut runner needs to be combined with the collaborative robot, and a bolt supplier and software that controls and manages the multi-axis nut runner and the bolt supplier is required.

In order to perform an object recognition technology and corresponding screw assembly, both recognition accuracy and collaborative robot location control resolution need to be improved.

As the accuracy of a part increases, its cost also rises. In contrast, if screw assembly work is omitted from a manufacturing line subsequently or if screw assembly needs to be performed in a narrow space where it is difficult for a collaborative robot to work in, such parts cannot be used.

Today, the manufacturing industry field aims at a sustainable industry, that is, one of the concepts of Industry 5.0, and attempts to reduce resources which cannot be used if a production line is changed.

Although humans cannot perform repetition work for a long time like a collaborative robot, with proper training and support from the system, humans can be more cost-effective and advantageous in terms of long-term production line expansion potential, compared to automating the system with a collaborative robot.

Conventional technologies are primarily related to an automation method of a collaborative robot. Even in the industry field, a method where a collaborative robot automatically works after a worker hands over an assembly part is commonly used.

However, humans can recognize a situation and adjust his or her power easily and rapidly compared to a collaborative robot.

In the case of the screw assembly work using the electric driver, which has been described above as an example, the collaborative robot has to accurately record its location and perform work. In contrast, a human can easily perform fastening work by moving his or her body as long as the human is positioned near the expected location of a screw hole.

Conventionally, a conventional collaborative robot needs to be periodically repaired and maintained because work accuracy of the collaborative robot is decreased if location errors occurring upon driving are accumulated. In contrast, a worker can easily correct such a location error problem.

Conventionally, there is a technology in which a collaborative robot performs screw assembly work in an unmanned way. To this end, a related automation module and object recognition software (SW) need to be added. In this case, there is a problem in that the utilization of the related automation module and the object recognition SW is limited if a manufacturing article is changed.

### SUMMARY

Various embodiments are directed to providing an article assembly method through collaboration between a worker and a collaborative robot so that the collaborative robot can be sustainably operated in the manufacturing industry.

Furthermore, various embodiments are directed to providing a system and method for supporting work through collaboration with a collaborative robot, in which a collaborative robot hands an assembly part over to a worker and the collaborative robot assists a portion that is performed by the worker, unlike the existing paradigm.

Objects of the present disclosure are not limited to the aforementioned object, and other objects not described above may be evidently understood by those skilled in the art from the following description.

A system for supporting work through collaboration with a collaborative robot according to an aspect of the present disclosure includes a posture estimation unit configured to estimate posture and body information of a worker based on an image of the worker, which is captured through a posture recognition camera module provided on one side of the worker, and to estimate the state of the worker based on the estimated posture and body information of the worker, an object recognition unit configured to recognize a work object article and the worker through an object recognition camera module provided over the worker and to measure a distance between the work object article and the worker, and a collaborative robot configured to transport the work object article in front of the worker by moving based on the estimated state of the worker, which is provided by the posture estimation unit, and the measured distance between the work object article and the worker, which is provided by the object recognition unit.

The posture estimation unit includes a posture recognition camera module provided on one side of the worker and configured to photograph a work posture of the worker who is working in and to transmit the work posture to a posture and body information estimation unit and a head and gaze estimation unit, the posture and body information estimation unit configured to continuously estimate in what posture the worker is working in by inferring a joint point of the worker and to calculate a height and arm length of the worker, the head and gaze estimation unit configured to measure posture, head, and gaze information of the worker for a long time, derive a standard state by calculating average values of posture, head, and gaze values, estimate head and gaze movements of the worker, and transmit the head and gaze movements to a worker state estimation unit, and the worker state estimation unit configured to confirm whether the worker is in a situation in which the worker requires work assistance based on results estimated by the posture and body information estimation unit and the head and gaze estimation unit.

The posture estimation unit further includes a nut runner posture estimation unit configured to calculate an angle formed by a nut runner and the work object article and to detect only one-axis information.

The object recognition unit includes an object recognition camera module configured to photograph a location of the work object article and a work location by using an RGB or RGB-D sensor and to transmit the photograph locations to an object recognizer, the object recognizer configured to determine the location of the work object article, the work location over the work object article, and a location of the worker based on photographing information transmitted by the object recognition camera module and to transmit the determined information to an assembly order generation unit and an inter-object distance estimation unit, and the inter-object distance measurement unit configured to confirm the location of the worker based on the information transmitted by the object recognizer and to calculate an absolute location to which the work object article is to be moved.

The object recognition unit further includes the assembly order generation unit configured to determine the work location by analyzing an image over the work object article and to derive an order of work to be performed.

The object recognition unit further includes an LED beam module configured to guide the work location to a laser point according to an order of screw assembly.

The object recognition unit further includes a driving controller configured to change a function for moving the LED beam module and an object recognition camera along a rail and photographing and a projection angle of a corresponding part.

The collaborative robot includes an article transport angle calculation module configured to receive a height and arm length of the worker from a posture and body information estimation unit and to receive size and work location information of the work object article from an inter-object distance estimation unit and a collaborative robot driving unit configured to determine and control transport and a tilt of the work object article by considering the height and arm length of the worker and a location of work based on values of the article transport angle calculation module.

The collaborative robot further includes a work assistance unit configured to determine whether a work assistance function is required by receiving results of estimation of a posture of a nut runner from a nut runner posture estimation unit capable of detecting an angle formed by the nut runner and the work object article at a corresponding location because the posture recognition camera module is installed on a side of the worker and receiving the size and work location information of the work object article from the inter-object distance measurement unit.

A method of supporting work through collaboration with a collaborative robot according to an aspect of the present disclosure includes determining, by a collaborative robot, a location of a screw hole through an object recognition camera module, determining, by the collaborative robot, an assembly order through an assembly order generation unit, transporting, by the collaborative robot, a work object article in front of a worker through a collaborative robot driving unit, determining, by the collaborative robot, whether a distance between the worker to a location of the screw hole is smaller than a threshold, and projecting LED light onto the location of the screw hole when the distance between the location of the screw hole over the work object article and the worker is smaller than the threshold in the determining of the distance.

The worker selects a next assembly location after performing screw assembly work when the work is completed.

The method further includes guiding the worker to stop work by projecting a red light source onto a surface of the work object article through an LED beam module while a transport angle of the work object article is adjusted when the distance between the location of the screw hole over the work object article and the worker is equal to or greater than the threshold in the determining of the distance and adjusting, by the collaborative robot, the transport angle of the work object article.

The method further includes indicating, by the collaborative robot, that the screw assembly work has been terminated through the LED beam module after the worker performs the screw assembly work by using a nut runner when a light source of the LED beam module is changed into a laser point and the laser point indicates a specific screw hole.

A method of supporting work through collaboration with a collaborative robot according to another aspect of the present disclosure includes transporting, by a collaborative robot, a work object article in front of a worker by adjusting an angle of the work object article, projecting LED light onto a location of a screw hole over the work object article, determining whether an angle formed by a nut runner and the work object article is a preset angle, and indicating a worker working command through LEDs when the angle formed by the nut runner and the work object article is the preset angle in the determining of the angle.

The method further includes inducing the worker to stop screw assembly by indicating a worker standby command through an LED beam module when the angle formed by the nut runner and the work object article is not the preset angle in the determining of the angle and correcting, by the collaborative robot, the angle formed by the nut runner and the work object article so that the angle becomes the preset angle by changing the angle of the work object article.

The inducing of the worker to stop the screw assembly includes finely adjusting the angle of the work object article so that the angle formed by the nut runner and the work object article becomes the preset angle through a collaborative robot driving unit when the worker waits in a state in which the nut runner has been attached to a screw head.

According to an embodiment of the present disclosure, it is possible to improve productivity compared to the work hour of a worker by reducing a work load of the worker through collaboration with a collaborative robot. There are effects in that a failure rate reduction effect can be achieved and a work danger index through musculoskeletal burden work can be lowered.

According to an embodiment of the present disclosure, there are effects in that sustainability and compatibility are high in that the system and method according to embodiments of the present disclosure can be used although manufacturing work is changed through the collaboration system of a worker and the collaborative robot.

According to an embodiment of the present disclosure, there are advantages in that a worker can work at a comfortable posture and a danger of wounds is reduced based on a musculoskeletal burden work evaluation table.

According to an embodiment of the present disclosure, it is possible to secure convenience and safety by limiting and reducing a movement of a worker.

### BRIEF DESCRIPTION OF THE DRAWINGS

FIG. 1 is a schematic diagram of a system for supporting work through collaboration with a collaborative robot according to an embodiment of the present disclosure.

FIG. 2 is a functional block diagram of the system for supporting work through collaboration with the collaborative robot according to an embodiment of the present disclosure.

FIG. 3 is an operating flowchart of the system for supporting work through collaboration with the collaborative robot according to an embodiment of the present disclosure.

FIG. 4 is an exemplary diagram in which the collaborative robot calculates a location where a work object article is transported and a tilt angle according to an embodiment of the present disclosure.

FIG. 5 is a flowchart of a method of supporting work through collaboration with the collaborative robot according to an embodiment of the present disclosure.

FIG. 6 is a flowchart for describing a method of the collaborative robot adjusting the tilt angle of a work object article according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims. Meanwhile, Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element.

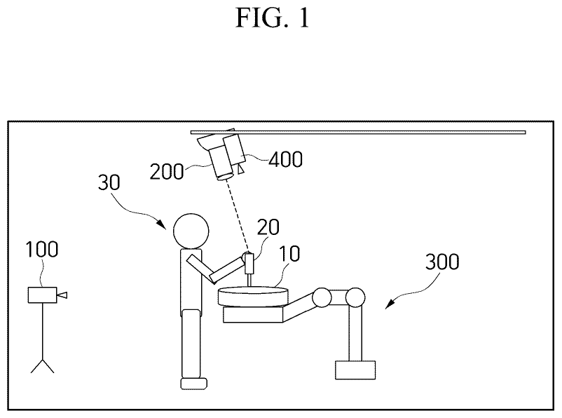

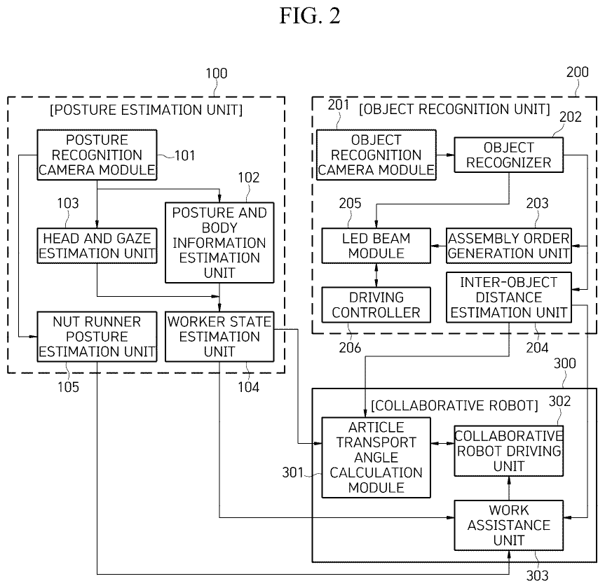

Hereinafter, embodiments of the present disclosure are described in detail with reference to the accompanying drawings. FIG. 1 is a schematic diagram of a system for supporting work through collaboration with a collaborative robot according to an embodiment of the present disclosure. FIG. 2 is a functional block diagram of the system for supporting work through collaboration with the collaborative robot according to an embodiment of the present disclosure.

As illustrated in FIGS. 1 and 2, a system and method for supporting work through collaboration with a collaborative robot according to embodiments of the present disclosure includes a posture estimation unit 100, an object recognition unit 200, and a collaborative robot 300.

The posture estimation unit 100 estimates posture and body information of a worker 30 from an image of the worker, which is captured by a posture recognition camera module 101 provided on one side of the worker, estimate the state of the worker based on the estimated posture and body information of the worker, and transmits the estimated state to the collaborative robot 300.

To this end, the posture estimation unit 100 includes the posture recognition camera module 101, a posture and body information estimation unit 102, a head and gaze estimation unit 103, a worker state estimation unit 104, and a nut runner posture estimation unit 105.

The posture recognition camera module 101 is provided on one side of the worker, photographs a work posture of the worker who works, and transmits the photographed work posture to the posture and body information estimation unit 102 and the head and gaze estimation unit 103.

The posture and body information estimation unit 102 continuously estimates in what posture the worker is working in by inferring the joint point of the worker based on an image captured by the posture recognition camera module 101, and calculates the height and arm length of the worker. For example, a method of estimating the joint point is a known technology, and a detailed description thereof is omitted.

The head and gaze estimation unit 103 measures posture, head, and gaze information of the worker for a long time, derives a standard state by calculating average values of posture, head, and gaze values, estimates head and gaze movements of the worker, and transmits the estimated head and gaze movements to the worker state estimation unit 104.

The worker state estimation unit 104 confirms whether the worker is in a situation in which the worker requires work assistance based on the results estimated by the posture and body information estimation unit 102 and the head and gaze estimation unit 103.

The nut runner posture estimation unit 105 is used to calculate an angle at which a nut runner 20 forms a work object article 10, and detects only one-axis information. In this case, the nut runner needs to be vertically installed with respect to a screw head. The left and right of the gaze of the worker are portions which may be autonomously confirmed, and are not greatly fallen outside. In contrast, if the nut runner is inclined in a direction close to the body of the worker, it is appropriate to check the angle of the nut runner through the nut runner posture estimation unit 105 because it may be difficult to determine the inclination.

The object recognition unit 200 recognizes the work object article and the worker through an object recognition camera module 201 provided over the worker, then measures a distance between the work object article and the worker, and transmits the measured distance to the collaborative robot 300.

To this end, the object recognition unit 200 includes the object recognition camera module 201, an object recognizer 202, an assembly order generation unit 203, an inter-object distance estimation unit 204, and a driving controller (an LED beam module 205 and a driving controller 206).

The object recognition camera module 201 photographs the location of the work object article and a work location by using an RGB or RGB-D sensor, and transmits the photographed locations to the object recognizer 202.

In response thereto, the object recognizer 202 determines the location of the work object article, a work location over the work object article, and the location of the worker based on the photographing information transmitted by the object recognition camera module 201, and transmits the determined information to the assembly order generation unit 203 and the inter-object distance estimation unit 204.

The assembly order generation unit 203 determines a work location (e.g., a screw hole) by analyzing an image over a work object article and derives the order of work (e.g., screw assembly) to be performed.

The inter-object distance measurement unit 204 confirms the location of the worker and calculates an absolute location to which the work object article will be moved, based on pieces of information transmitted by the object recognizer 202.

The LED beam module 205 guides the work location to a laser point according to the order of screw assembly. The LED beam module 205 projects a light source or a laser onto a surface of the work object article or the location of specific work (e.g., a screw hole) depending on a situation.

The driving controller 206 may change functions of the LED beam module 205 and the object recognition camera that are moved along a rail and photographing and projection angles of a corresponding part.

When the work object article is determined by the object recognizer 202, the collaborative robot 300 picks up the work object article and transports the work object article in front of the worker.

The collaborative robot 300 moves based on the estimated state of the worker, which is provided by the posture estimation unit 100, and the measured distance between the work object article and the worker, which is provided by the object recognition unit 200, and transports the work object article 10 in front of the worker. In an embodiment of the present disclosure, a joint robot is preferably used as the collaborative robot 300, but the present disclosure is not limited thereto.

The collaborative robot 300 includes an article transport angle calculation module 301, a collaborative robot driving unit 302, and a work assistance unit 303.

The article transport angle calculation module 301 receives the height and arm length of the worker from the posture and body information estimation unit 102 and receives information on the size of the work object article and the location of the work (e.g., a screw hole) through the inter-object distance measurement unit 204.

The collaborative robot driving unit 302 determines and controls transport and the tilt of the work object article by considering the height and arm length of the worker and the location of the work (e.g., a screw hole) based on the values of the article transport angle calculation module 301.

The work assistance unit 303 receives the results of the estimation of the posture of the nut runner from the nut runner posture estimation unit 105 capable of detecting an angle formed by the nut runner 20 and the work object article 10 at a corresponding location because the posture recognition camera module 101 is installed on the side of the worker, receives the size and work location information of the work object article from the inter-object distance measurement unit 204, and determines whether the work assistance function is required.

Accordingly, according to an embodiment of the present disclosure, there are effects in that sustainability and compatibility are high in that the system and method according to embodiments of the present disclosure can be used although manufacturing work is changed through the collaboration system of the worker and the collaborative robot.

According to an embodiment of the present disclosure, there are advantages in that a worker ca work at a comfortable posture and a danger of wounds is reduced based on a musculoskeletal burden work evaluation table.

According to an embodiment of the present disclosure, it is possible to secure convenience and safety by limiting and reducing a movement of a worker According to an embodiment of the present disclosure, even from a viewpoint of monitoring a worker, it is possible to reduce an unnecessary movement by limiting the posture and behavior pattern of the worker. Furthermore, it is possible to detect a subtle change of a worker which may occur due to fatigue or decreased concentration.

According to an embodiment of the present disclosure, a worker can take measures although a manufacturing article is changed. The collaborative robot can assist a worker in order to overcome a reduction of production efficiency of the worker attributable to fatigue.

According to an embodiment of the present disclosure, it is possible to take measures although a manufacturing article and manufacturing work are changed because the collaborative robot assists a worker to smoothly work in.

In an embodiment of the present disclosure, a screw assembly is taken as an example, but an embodiment of the present disclosure may also be applicable to tasks such as painting, product disassembly at recycling centers, and quality inspection.

Hereinafter, according to an embodiment of the present disclosure, an example of work that is performed by the posture estimation unit 100 and the object recognition unit 200 in order for the collaborative robot to transport a work object article, that is, the work object article, to a worker is described.

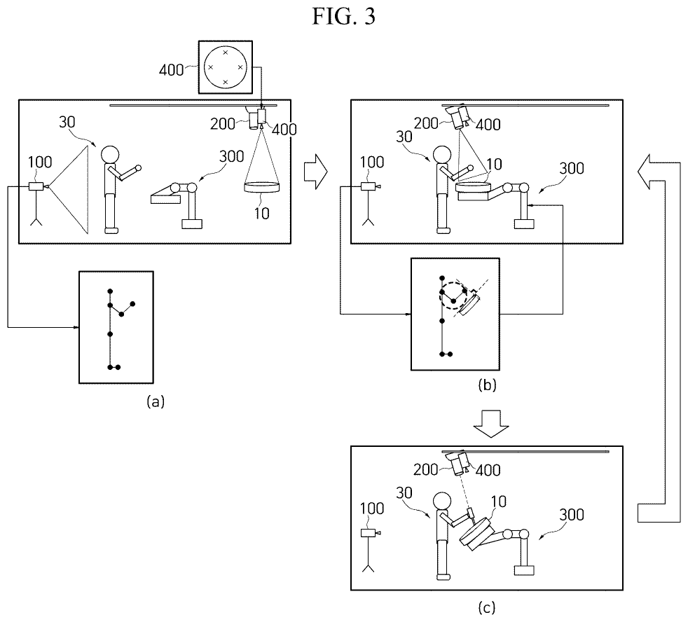

As illustrated in FIG. 3(a), the posture recognition camera module 101 estimates the height and arm length of the worker. The object recognition camera module 201 confirms the location of the work object article and the location of work (e.g., a screw hole) through the object recognizer 202.

As illustrated in FIG. 3(b), if object recognition for a work object article is impossible because the view of the object recognition camera module 201 is blocked by the worker, the collaborative robot 300 issues a stop command so that the worker does not perform work by projecting a red light source onto a surface of the work object article through the LED beam module 205. Thereafter, the collaborative robot 300 determines at which location in front of the worker the work object article will be transported through the posture and body information estimation unit 102 and the inter-object distance measurement unit 204. The collaborative robot 300 moves to a location where the work object article can be confirmed through the driving controller 206.

Thereafter, as illustrated in FIG. 3(c), when moving to the worker, the collaborative robot 300 indicates the start point of work (e.g., a screw hole assembly) on the work object article by a laser point when the transport of the work object article and an arbitrary tilt thereof are prepared, and enables the worker to perform the work.

If the light source or a laser are blocked by the work object article due to the worker without reaching the work object article, the work object article may be moved to the place where the light source or the laser is reached through the driving controller 206.

An embodiment of the present disclosure describes an example in which the collaborative robot calculates the location where the work object article is transported and the tilt angle of the work object article.

According to an embodiment of the present disclosure, when the musculoskelet burden work hazard of a worker is evaluated in a manufacturing industry, a danger is determined by deriving a rapid upper limb assessment (REBA) or rapid entire body assessment (RULA) score.

In an evaluation method according to an embodiment of the present disclosure, a danger index is determined based on how much worker moves the angles of the shoulder, forearm, and wrist.

For example, the danger score of the shoulder is increased in the case of work in which the worker moves forward by 20 degrees or more. Whether the wrist is fallen outside by 15 degrees or more is checked.

In an embodiment of the present disclosure, the collaborative robot 300 transports the work object article 10 so that the shoulder of a worker 30 is moved within 20 degrees in front of his or her body with reference to the musculoskeletal burden work evaluation table.

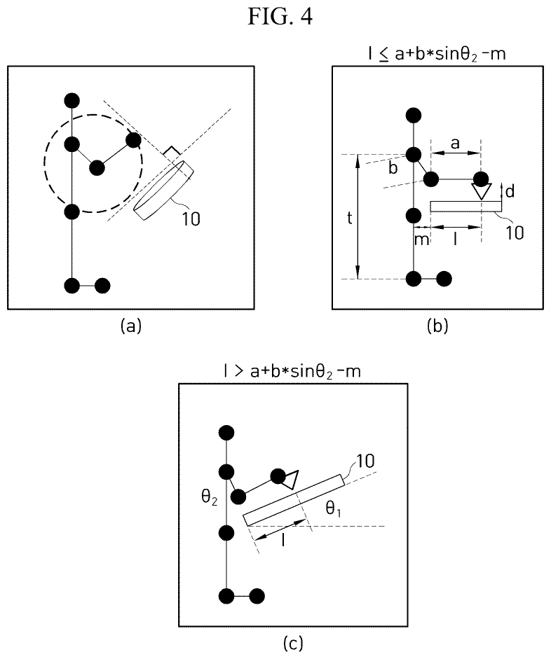

As illustrated in FIG. 4(a), the posture of the collaborative robot 300 that holds the forearm of the worker and the nut runner 20 to be perpendicular to each other is maintained so that the wrist of the worker that holds the nut runner 20 is not bent.

A method of the collaborative robot 300 transporting the work object article 10 may be defined as two types. One of the two types is a method of setting only the location of the work object article 10 to be convenient for the worker without inclining the work object article as illustrated in FIG. 4(b). The other of the two types is a method of transporting the work object article 10 in front of the worker by inclining the work object article 10 when the work object article 10 is large and a point at which bolt fastening work needs to be performed is far away from the body of the worker as illustrated in FIG. 4(c).

As illustrated in FIG. 4(b) and 4(c), the location of the work object article 10 may be calculated based on the shoulder-elbow length “b” and elbow-wrist length “a” of the worker 30, a safety distance “m” between the work object article 10 and the worker 30, and a distance “l” up to a bolt fastening point within the work object article 10, an angle “θ2” at which the shoulder of the worker is rotated in front of the body of the worker, a worker shoulder height “t”, and a nut runner length “d”.

In this case, the angle “θ2” at which the shoulder of the worker is rotated is within 20 degrees. If the work object article 10 needs to be inclined because the length “l” is long, a tilt angle “θ1” of the work object article 10 is defined.

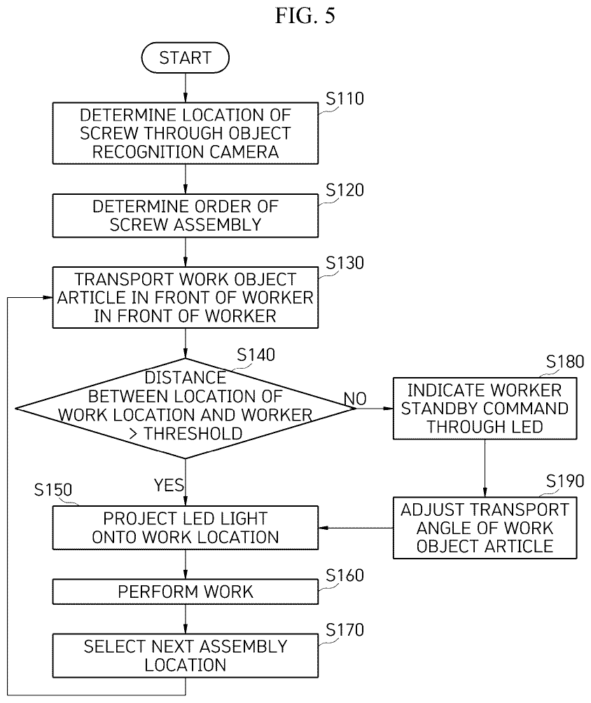

FIG. 5 is a flowchart in which the collaborative robot transports a work object article to a worker according to an embodiment of the present disclosure.

The collaborative robot 300 determines the location of work (e.g., a screw hole) (S110) through the object recognition camera module 201, determines the order of assembly through the assembly order generation unit 203, and sets the work (S120).

Thereafter, the collaborative robot 300 transports a work object article in front of a worker through the collaborative robot driving unit 302 (S130). Thereafter, the collaborative robot 300 determines whether a distance between the location of the screw hole and the worker is smaller than a threshold (S140).

When the distance between the location of the screw hole on the work object article 20 and the worker is smaller than the threshold (YES) in step S140, LED light is projected onto the location of the screw hole (S150). After the worker performs the screw assembly work (S160), and a next assembly location is selected (S170).

In contrast, when the distance between the location of the screw hole on the work object article 20 and the worker is the threshold or more (NO) in step S140, while the transport angle of the work object article is adjusted, a red light source is projected onto a surface of the work object article through the LED beam module 205 so that the worker stops the screw assembly work (S180). Thereafter, while the transport angle of the work object article is adjusted (S190).

Next, when the light source of the LED beam module 205 is changed into a laser point and the laser point indicates a specific screw hole, the worker performs the screw assembly work by using the nut runner (S160).

When the termination of the screw assembly work is checked based on the results of monitoring by the posture and body information estimation unit 102, the LED beam module 205 projects a laser point onto the location of a next screw hole.

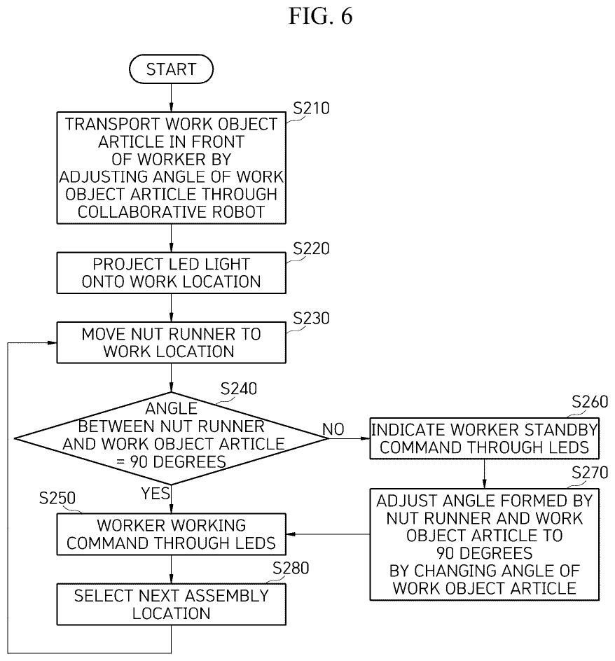

FIG. 6 is a flowchart of a function for compensating for, by the collaborative robot, a work error of a worker when collaborative work efficiency of the worker is low.

First, a work object article is transported in front of a worker by adjusting the angle of the work object article through the collaborative robot (S210).

Thereafter, when LED light is projected onto the location of a screw hole of the work object article (S220), the worker moves the nut runner to the location of the screw hole (S230).

In response thereto, the collaborative robot determines whether an angle formed by the nut runner and the work object article is 90 degrees (S240). In assembly collaboration work in which a nut is assembled according to the present embodiment, it is important for the nut runner 20 and a screw head to be perpendicular to each other.

To this end, before the worker moves the nut runner to the location of the screw hole and performs screw assembly work, the collaborative robot 300 calculates an angle formed by a posture of the nut runner detected by the nut runner posture estimation unit 105 and a surface of the work object article.

When the angle formed by the nut runner and the work object article is 90 degrees (YES) in the determination step S240, a worker working command is indicated through LEDs (S250).

Thereafter, a next assembly location is selected again (S280).

In contrast, when the angle formed by the nut runner and the work object article is not 90 degrees (NO) in the determination step S240, the worker is induced to stop the screw assembly work by indicating a worker standby command through the LED beam module 205 (S260).

The collaborative robot corrects the angle of the work object article so that the angle formed by the nut runner and the work object article is 90 degrees by changing the angle of the work object article (S270). That is, if the worker waits in the state in which the nut runner has been attached to a screw head, the collaborative robot finely adjusts the angle of the work object article through the collaborative robot driving unit 302 so that the angle formed by the nut runner and the work object article becomes 90 degrees.

A red light source is changed into a laser point through the LED beam module 205 and a working command is indicated to the worker so that the worker can perform the screw assembly work (S250).

As described above, according to an embodiment of the present disclosure, it is possible to compensate for a situation in which it is difficult for a worker and the nut runner 20 to be perpendicular to each other because the worker becomes more and more fatigued due to long-time work or a work object article is inclined.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

The constructions of the present disclosure have been described in detail above with reference to the accompanying drawings, but are merely illustrative. A person having ordinary knowledge in the art to which the present disclosure pertains will understand that various modifications and changes are possible without departing from the technical spirit of the present disclosure. Accordingly, the scope of the present disclosure should not be limited to the aforementioned embodiments, and should be defined by the writing of the appended claims.

What is claimed is:

1. A system for supporting work through collaboration with a collaborative robot, the system comprising:
a posture estimation unit configured to estimate posture and body information of a worker based on an image of the worker, which is captured through a posture recognition camera module provided on one side of the worker, and to estimate a state of the worker based on the estimated posture and body information of the worker;
an object recognition unit configured to recognize a work object article and the worker through an object recognition camera module provided over the worker and to measure a distance between the work object article and the worker; and
a collaborative robot configured to transport the work object article in front of the worker by moving based on the estimated state of the worker, which is provided by the posture estimation unit, and the measured distance between the work object article and the worker, which is provided by the object recognition unit.

2. The system of claim 1, wherein the posture estimation unit comprises:
a posture recognition camera module provided on one side of the worker and configured to photograph a work posture of the worker who is working in and to transmit the work posture to a posture and body information estimation unit and a head and gaze estimation unit;
the posture and body information estimation unit configured to continuously estimate in what posture the worker is working in by inferring a joint point of the worker and to calculate a height and arm length of the worker;
the head and gaze estimation unit configured to measure posture, head, and gaze information of the worker for a long time, derive a standard state by calculating average values of posture, head, and gaze values, estimate head and gaze movements of the worker, and transmit the head and gaze movements to a worker state estimation unit; and
the worker state estimation unit configured to confirm whether the worker is in a situation in which the worker requires work assistance based on results estimated by the posture and body information estimation unit and the head and gaze estimation unit.

3. The system of claim 2, wherein the posture estimation unit further comprises a nut runner posture estimation unit configured to calculate an angle formed by a nut runner and the work object article and to detect only one-axis information.

4. The system of claim 1, wherein the object recognition unit comprises:
an object recognition camera module configured to photograph a location of the work object article and a work location by using an RGB or RGB-D sensor and to transmit the photograph locations to an object recognizer;
the object recognizer configured to determine the location of the work object article, the work location over the work object article, and a location of the worker based on photographing information transmitted by the object recognition camera module and to transmit the determined information to an assembly order generation unit and an inter-object distance estimation unit; and
the inter-object distance measurement unit configured to confirm the location of the worker based on the information transmitted by the object recognizer and to calculate an absolute location to which the work object article is to be moved.

5. The system of claim 4, wherein the object recognition unit further comprises the assembly order generation unit configured to determine the work location by analyzing an image over the work object article and to derive an order of work to be performed.

6. The system of claim 5, wherein the object recognition unit further comprises an LED beam module configured to guide the work location to a laser point according to an order of screw assembly.

7. The system of claim 6, wherein the object recognition unit further comprises a driving controller configured to change a function for moving the LED beam module and an object recognition camera along a rail and photographing and a projection angle of a corresponding part.

8. The system of claim 1, wherein the collaborative robot comprises:
an article transport angle calculation module configured to receive a height and arm length of the worker from a posture and body information estimation unit and to receive size and work location information of the work object article from an inter-object distance estimation unit; and
a collaborative robot driving unit configured to determine and control transport and a tilt of the work object article by considering the height and arm length of the worker and a location of work based on values of the article transport angle calculation module.

9. The system of claim 8, wherein the collaborative robot further comprises a work assistance unit configured to determine whether a work assistance function is required by receiving results of estimation of a posture of a nut runner from a nut runner posture estimation unit capable of detecting an angle formed by the nut runner and the work object article at a corresponding location because the posture recognition camera module is installed on a side of the worker and receiving the size and work location information of the work object article from the inter-object distance measurement unit.

10. A method of supporting work through collaboration with a collaborative robot, the method comprising:
determining, by a collaborative robot, a location of a screw hole through an object recognition camera module;
determining, by the collaborative robot, an assembly order through an assembly order generation unit;
transporting, by the collaborative robot, a work object article in front of a worker through a collaborative robot driving unit;
determining, by the collaborative robot, whether a distance between the worker to a location of the screw hole is smaller than a threshold; and
projecting LED light onto the location of the screw hole when the distance between the location of the screw hole over the work object article and the worker is smaller than the threshold in the determining of the distance.

11. The method of claim 10, wherein the worker selects a next assembly location after performing screw assembly work.

12. The method of claim 10, further comprising:
guiding the worker to stop work by projecting a red light source onto a surface of the work object article through an LED beam module while a transport angle of the work object article is adjusted when the distance between the location of the screw hole over the work object article and the worker is equal to or greater than the threshold in the determining of the distance; and
adjusting, by the collaborative robot, the transport angle of the work object article.

13. The method of claim 10, further comprising indicating, by the collaborative robot, that the screw assembly work has been terminated through the LED beam module after the worker performs the screw assembly work by using a nut runner when a light source of the LED beam module is changed into a laser point and the laser point indicates a specific screw hole.

14. A method of supporting work through collaboration with a collaborative robot, the method comprising:
transporting, by a collaborative robot, a work object article in front of a worker by adjusting an angle of the work object article;
projecting LED light onto a location of a screw hole over the work object article;
determining whether an angle formed by a nut runner and the work object article is a preset angle; and
indicating a worker working command through LEDs when the angle formed by the nut runner and the work object article is the preset angle in the determining of the angle.

15. The method of claim 14, further comprising:
inducing the worker to stop screw assembly by indicating a worker standby command through an LED beam module when the angle formed by the nut runner and the work object article is not the preset angle in the determining of the angle; and
correcting, by the collaborative robot, the angle formed by the nut runner and the work object article so that the angle becomes the preset angle by changing the angle of the work object article.

16. The method of claim 15, wherein the inducing of the worker to stop the screw assembly comprises finely adjusting the angle of the work object article so that the angle formed by the nut runner and the work object article becomes the preset angle through a collaborative robot driving unit when the worker waits in a state in which the nut runner has been attached to a screw head.
